(19) United States
(12) Patent Application Publication
(10) Pub. No.: US 2003/0211618 A1
(43) Pub. Date: Nov. 13, 2003

(54) Color changing steam sterilization indicator

(76) Inventor: Gordhandhai Nathalal Patel, Somerset, NJ (US)

Correspondence Address: John B Hardaway, Nexsen Pruet Jacobs & Pollard, P O Box 10107, Greenville, SC, 29603, US

(21) Appl. No.: 10/275,228

(22) PCT Filed: May 7, 2001
(86) PCT No.: PCT/US01/14604

(51) Int. Cl. G01N 31/22

(52) U.S. Cl. 436/38; 422/56

(57) ABSTRACT

There is provided a device (10) for monitoring sterilization of a material with steam comprising at least one layer (20), having incorporated therein an isomeric indicator (22), capable of undergoing at least one color change and optionally a controller (23) for said indicator capable of influencing the time and temperature required for said color change when contact with steam. Composed of polymeric binder (21).

### BACKGROUND OF TIE INVENTION

1. Field of the Invention

The present invention relates to a color-changing device for monitoring integral value of time, temperature and steam. The device can be used for monitoring sterilization of medical and kitchen supplies, canned foods and doneness of microwave foods.

2. Brief Description of Prior Art

A wide variety of medical supplies are sterilized with materials and techniques, such as steam, ethylene oxide, plasma, peracetic acid, formaldehyde and high-energy radiation. Kitchenware, such as dishes, cutlery, and utensils used at home and restaurants are also sterilized in dishwashers with hot water and hot air usually around 90° C. It is essential to assure that these items are sterilized. A number of indicators, dosimeters and monitors are proposed in the literature. They include biological and chemical indicators. The color changing chemical indicators are inexpensive and are widely used.

In order to assure the sterilization with steam, the indicator, or dosimeter, must determine integral value of three parameters viz. time, temperature and steam. It is often desirable that the indicator is essentially unaffected by other parameters, such as dry heat, humidity, steam, ethylene oxide and radiation.

Pre-cooked frozen food is widely used today. The pre-cooked frozen food is heated either in a conventional oven (for example, heated with natural gas or electricity) or more conveniently in a microwave oven. A microwave oven does not heat the food uniformly. Some portions of food may not be done while the other portions may be over heated. Hence, there is a need for an indicator that changes color when steam is emitted by the food.

Homes, restaurants and catering organizations use kitchenware such as dishes, cutlery and utensils, which need to be sterilized with either dry heat, hot water and steam usually below 100° C. There is also a need for an indicator to make sure that the cookware has been subjected to certain integral value of heat and/or humidity.

A wide variety of foods especially canned foods, pharmaceuticals, hospital and medical supplies are sterilized. These and other products such as linens are sterilized to kill living organisms to an acceptable level. Direct testing for sterility is destructive and expensive and hence indirect testing methods, such as color changing indicators are used.

Biological indicators made from cultures, such as Bacillus subtilis spores, bacillus pumilus spores and clostridiumn sporogenes spores are used for monitoring the sterilization. However, chemical indicators are widely used because they are simple and inexpensive.

Many steam sterilization indicators are reported in the literature and some of them are used for monitoring sterilization. A few of them use heavy and toxic metals, such as lead. There is a need for a sterilization indicator that does not use toxic and heavy metals.

U.S. Pat. No. 3,523,011 describes an indicator material consisting of calcium sulfide and lead carbonate. Upon exposure to steam at ˜120° C., calcium sulfide decomposes to form calcium hydroxide and hydrogen sulfide. The hydrogen sulfide reacts with lead carbonate to form black lead sulfide. Steam sensitive composition of U.S. Pat. No. 5,064,576 contains a metal complex (e.g. zirconium chloranilate) and an exchange ligand (e.g. citric or tartric acid salts and amino carboxylic acid), binder (e.g. nitrocellulose and ethylcellulose) and a color change rate regulator (e.g. Resino blue, Resino yellow). U.S. Pat. No. 4,514,361 discloses a steam sterilization indicator containing a carrier (e.g. filter paper), a pH value indicator (e.g. bromocresol purple) and a chemical composition that contains (a) 2,4-dihydroxybenzoic acid and its metal salt and (b) phenylpropionic acid and its metal salt. Under steam sterilization conditions, the pH of mixture exceeds pre-determined pH (5.8 to 6.2) due to formation of carbonate or bicarbonate (basic), causing the indicator to change color and indicate that sterilization is complete. U.S. Pat. No. 5,158,363 describes a steam sterilization indicator, which contain (a) water-soluble organic compound whose melting point in the absence of steam is greater than sterilization temperature and (b) ink dye. Upon steam exposure, dye changes color from clear to dark brown or black. U.S. Pat. No. 5,087,659 describes ink composition as steam sterilization indicators for use in jet printing. The composition uses an organic dyestuff, which forms a salt with phenol resin. The ink composition is discolored or changes color under steam sterilization conditions. U.S. Pat. Nos. 3,981,683, 3,932,134, 4,195,055 and 4,410,493 illustrate processes, which use permeation or wicking of an indicator chemical (such as sebasic acid and salicylamuide) and a dye. A disposable pre-vacuum steam sterilizer test device is described in U.S. Pat. No. 4,486,387. Other indicators for noting the completion of steam sterilization are reported in U.S. Pat. Nos. 4,121,714; 3,360,339; 2,826,073; 3,568,627; 3,360,338; 2,798,885; 3,386,807; 3,360,337; and 3,862,824. The indicators, which monitor integral value of time, temperature and humidity are often commonly referred to as steam indicators herein.

Patel in PCT application number # WO 01/10471 A1 has disclosed ink formulations and devices for monitoring sterilization with ethylene oxide. The device is made by coating a mixture of (a) a polymeric binder, (b) a ethylene oxide reactive salt, such as sodium thiocyanate and tetraethylammonium bromide and (c) a pH sensitive dye, such as bromothymol blue and bromocresol purple. When contacted with ethylene oxide, the device undergoes at least one color change due to production of a base such as sodium hydroxide. However, these devices and formulations are selective to ethylene oxide only.

Patel in PCT application # WO 00/61200 has disclosed formulations and devices for monitoring sterilization with plasma. The device is made by coating of a mixture of at least one (a) polymeric binder, (b) plasma activator and (c) plasma indicator. The device undergoes a color change when treated with plasma, especially that of hydrogen peroxide. For example, when a coating of phenol red and tetraethylammonium bromide in a binder, such as polyacrylate undergoes a color change from yellow-to-blue when exposed to hydrogen peroxide and its plasma due to halogenation of the dye. However, these devices and formulations are selective to plasma only.

Even though equilibrium processes which include reversible reactions, interconversions such as migration of atoms such as hydrogen, structural changes, isomerizations, configuration changes such as cis ⇄ trans, stereoisomerisation, isomeric transitions, polymorphism, isomorphism, phase changes and tautomerism are known, there is no report on use of such processes and compounds undergoing isomerization for monitoring integral value of time, temperature and moisture.

Many dyes and pigments gets oxidized and reduced with oxidizing and reducing agents respectively. Oxidation and reduction processes are often associated with a color change. These dyes are usually known as redox dyes. Some examples of redox dyes are: neutral red, dimethylindoaniline, indigodisulfonic acid, nile blue A, methylene blue, thionin, brilliant cresyl blue, dichloroindophenol, dimethoxybenzidine, diphenylbezidine, diphenylamine, o-toludine, bezopurprin 4B and naphthol blue black. A number of color changing redox systems are summarized in a book by E. Bishop [for example, see chapter 8 in “Indicators”, E. Bishop (Ed), Pergamon Press, Oxford, 1972]. Chapter 7 of this book describes some adsorption indicators. Adsorption indicators which change color with humidity can be used as steam indicators.

A number of dyes also change color with solvents, usually with change in polarity of the solvent, hydrogen bonding, donation and acceptance of electron pairs Some dyes also change color when dissolved. These dyes are commonly referred to as solvatochromic dyes. Solvatochromic dyes are summarized in a review by C. Reichardt [Chemical Reviews, 94, 2319-2358 (1994) and references quoted therein]. An example of solvatochromic dyes is N-phenoxide betaine, Michler's ketone, Nile red, phenol blue, iron phenanthroline and some mecrocyanine, and stilbenzonium dyes.

The above referred processes are collectively or individually referred herein to as isomerization process(es) and compound(s) undergoing isomerization as isomer(s). The isomers, including dyes which change colors, when they transform from one isomeric form to the other, without going through a major chemical reactions, are collectively and/or individually referred herein as to isomeric indicators or simply indicators.

### SUMMARY OF THE INVENTION

It is an object of the present invention to provide an indicator which can monitor integral value of temperature, time and water vapor. It is another object of the present invention to provide an indicator which is economical to manufacture and use.

Provided is a device made by coating a mixture of (a) a polymeric binder, (b) an isomeric indicator and optionally (c) a controller which controls the time and temperature of isomerization of the said indicator, when contacted with water vapor, undergoes at least one color change. Such a device can be used for monitoring sterilization of medical supplies and canned foods, and doneness of microwave foods.

Also provided is a device for monitoring integral value of time, temperature and water vapor comprising at least one layer of polymer, having incorporated therein (a) an isomeric indicator capable of undergoing at least one color change and optionally (b) a controller for said indicator wherein said indicator, when contacted with water vapor, undergoes an isomerization reaction which causes said indicator to undergo said color change.

The indicators suitable for use in this device include pigments, dyes, precursors of them, and their mixtures. A desirable quality of the indicator is the ability to undergo a color change upon isomerization, with or without a controller, when contacted with water vapor. Desirably the indicator undergoes a yellow-to-blue, yellow-to-green, red-to-yellow, red-to-green, red-to-blue or vice versa color change. Suitable indicators include dyes having ability to isomerize, or change to a tautomer or formation or breaking a hydrogen bond, get oxidized or reduced, or get dissolved.

A preferred polymer used in the device is, suitably, soluble in water or dispersible in an aqueous medium solvent. The polymer can also be formed by polymerization with high energy radiation, such as UV and electron beam. A broad class of polymers may be used. They may be homopolymers, copolymers or a mixture thereof, suitably a vinyl or olefin polymers, such as that of styrenes, acrylates, acrylic acid, acrylamide, vinyl acetate, vinyl alcohol, vinyl chloride, epoxide, polyurethanes, cellulose nitrate, carboxyethyl cellulose or a mixture thereof. Desirably, the polymer is an acrylate polymer, polyurethane, cellulose nitrate or carboxymethylcellulose.

Preferably the controller is a compound having the ability to influence the rate and temperature of isomerization of said indicator when contacted with water vapor. The nature of controller depends upon the isomerization process. Controller could also be an isomeric compound e.g., a derivative or complex of acetoacetic acid and 2,4-pentanedione (acetylacetone). Suitable controllers are tautomers or compounds having ability to form hydrogen bonds, dissolve, oxidize or reduce the indicator. Desirable controller includes acids, acetylacetonates, aldehydes, alcohols, amides, amidrazones, amines, azo, dithiocarbamates, esters, hydrazides, hydrazones, hydroxyamines, imidazoles, imadozolines, imides, imines, indolines, ketones, lactams, lactones, nitramides, nitriles, nitrones, oximes, pentanediones, phosphates, phthalides, pyrimidines, semicarbazones, thiophenes, thioureas, triazenes, triazoles, ureas, solid solvents, oxidizing and reducing agents or a mixture thereof. Controller may not interact with said indicator or may stabilize the isomeric form under normal ambient conditions. Other additives may be used to stabilize the ambient form or the steam treated form of said indicators.

The process of making a device of the present invention comprises dissolving or dispersing the components such as the indicator, controller and binder in a solvent thereof, applying the thus formed solution/dispersion to a substrate and permitting the solvent to evaporate. The process also includes dissolving or dispersing the components in monomers and oligomers polymerizable with high energy radiation, such as UV light and electron beam, and curing them to a polymer with such radiation.

The substrate may be a container for an item to be sterilized. It may also be a plastic film, paper or metal, including but not limited to polyester film, paper or spun bonded polyolefins.

In a desirable embodiment of the invention is a solution or dispersion of an ink formulation suitably an aqueous ink formulation most suitably one, which comprises an acrylate polymer.

A process of using a device of the present invention for monitoring sterilization of materials and doneness of food comprises the steps of affixing the device to said materials or containers containing same, carrying out the process of sterilization including the step of exposing the device to water vapor including high pressure steam and observing the presence of a color change of said device.

A particularly preferred embodiment is provided in a device for monitoring integral value of time, temperature and water vapor. The device comprises at least one layer of polymer comprising an indicator wherein an isomeric indicator capable of undergoing at least one color change and 0-50%, by weight, a controller for the indicator which is capable of influencing the time and temperature required for the color change to occur when contacted with water vapor. The indicator undergoes an isomerization reaction which causes the indicator to undergo said color change.

Yet another embodiment is provided in a process of making a device comprising:

a) dissolving or dispersing an indicator in a solvent to form a solution;

b) applying the solution to a substrate; and

c) permitting the solvent to evaporate.

Also provided is ink formulation for making the devices for monitoring integral value of time, temperature and water vapor, comprising polymeric binder, solvent, indicator and controller.

### BRIEF DESCRIPTION OF THE DRAWINGS

FIG. 1. A side schematic cross section of one embodiment of the steam sterilization indicator of the invention wherein an indicator layer comprised of a polymeric binder, isomeric indicator and optionally a controller for the indicator is applied on a substrate.

FIG. 2. A side schematic cross section of the steam sterilization indicator of the invention having an adhesive layer and a release layer.

FIG. 3. A side cross-section of a multi-layer device wherein a top layer is a coating or lamination as a barrier.

FIG. 4. A side schematic cross section of another embodiment of the steam indicator device which is substantially the same as that in FIG. 1 except that the device is applied under the lid of a microwave food container.

FIG. 5. An equation for a tautomeric reaction and examples of azo ⇄ hydrazo tautomers.

FIG. 6. Chemical structures of two isomers of direct blue 71.

FIG. 7. Formation of two isomers by interaction with a controller.

FIG. 8. Metachromism of Nile blue A and Cresyl violet acetate introduced by water.

FIG. 9. Oxidized and reduced form of methylene blue.

### BRIEF DESCRIPTION OF THE INVENTION AND PREFERRED EMBODIMENTS

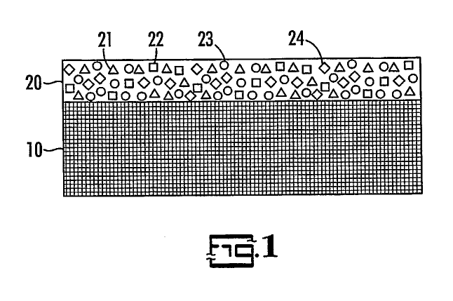

The device can be best described by reference to the Figures. As shown in FIG. 1, the device in one of the simplest form is comprised of an indicator layer X, applied on a substrate 10. The substrate 10 can also be a container, such as pouch or can for products to be sterilized or a food container. The indicator layer 20 is composed of a polymeric binder 21, and containing at least one isomeric indicator 22, capable of undergoing a color change when contacted with steam. The indicator layer 20 may optionally contain a controller 23 to control e.g., the time and temperature required for the color change. The indicator layer 20 may contain other additives 24 such as a stabilizer for the isomeric indicator, crosslinking agent or UV absorber.

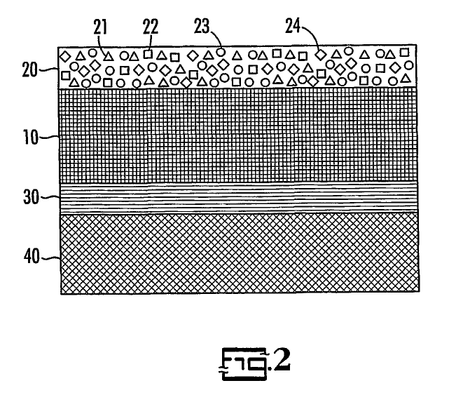

As shown in FIG. 2, the substrate 10 of the device can optionally be a film or paper coated with an adhesive layer 30. The adhesive layer allows the device to be affixed to a container of product to be sterilized. To the bottom of the adhesive layer 30, can be affixed a release layer 40 for ease in packaging and for removal just prior to use. Removal of the release layer 40 will enable the entire device to be affixed to the container of product to be sterilized.

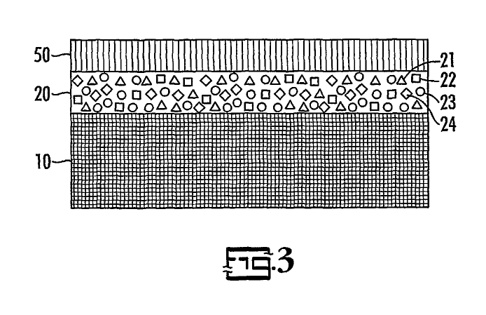

The device can be composed of more than one layer. The device could have two indicator layers. As shown in FIG. 3, in its simplest form of the multi-layer device, the second top layer 50 could be a barrier for steam, e.g., a polymeric coat or a laminated film, on to layer 20. The barrier layer 50 can reduce diffusion of steam, thereby increasing the time required for the color change. The top layer 50 can be a transparent laminated film. The indicator layer can also be sandwiched between two films or between a paper and a film.

A moving boundary device can be created if the barrier layer 50 is in the form of a wedge over the indicator layer 20. The barrier layer will resist but will be permeable to steam.

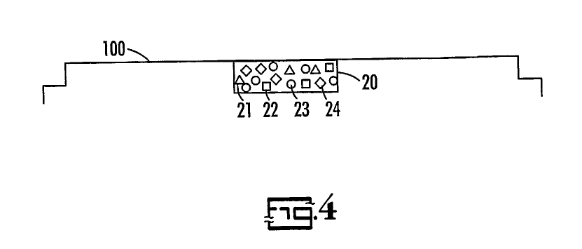

The device can be used for monitoring doneness of microwave and other foods. The device of FIG. 1 or FIG. 2 can be applied under a lid of the microwave food container. FIG. 4 is a side schematic cross section of another embodiment of the device where the indicator layer 20 is applied under the lid 100 of a microwave food container.

Other variations of the steam indicator device are also possible, for example, a gradient device can be created by coating a series of formulations having the time required for the color change either increases or decreases. Such gradient can be obtained by coating such formulations in form of lines or bars next to each other.

The device could also be created by printing the indicating formulation in form of a number, image, bar code or message, e.g., “if this print is green, the product inside is sterilized”.

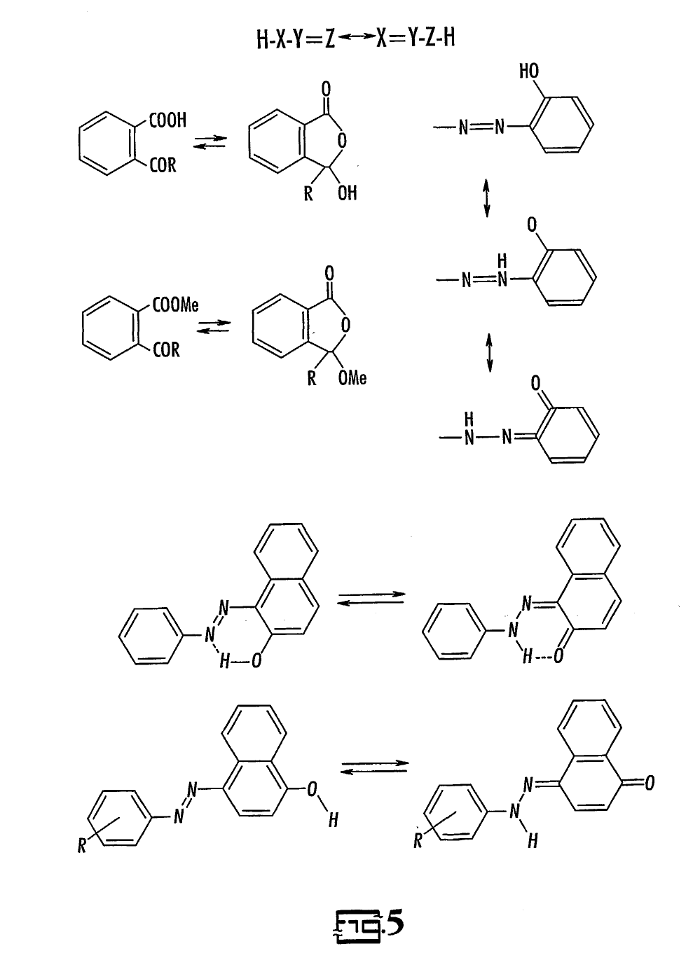

An example of a keto-enol, amido-imido, thiol-thione, type isomerization reaction (H—X—Y═Z⇄ X═Y—Z—H) of the present invention is shown in FIG. 5. A typical example is acetoacetic acid and its derivatives which can exist as a keto (CH₃COCH₂COOCH₂CH₃) and enol (CH₃C(OH)═CHCOOCH₂CH₃) forms.

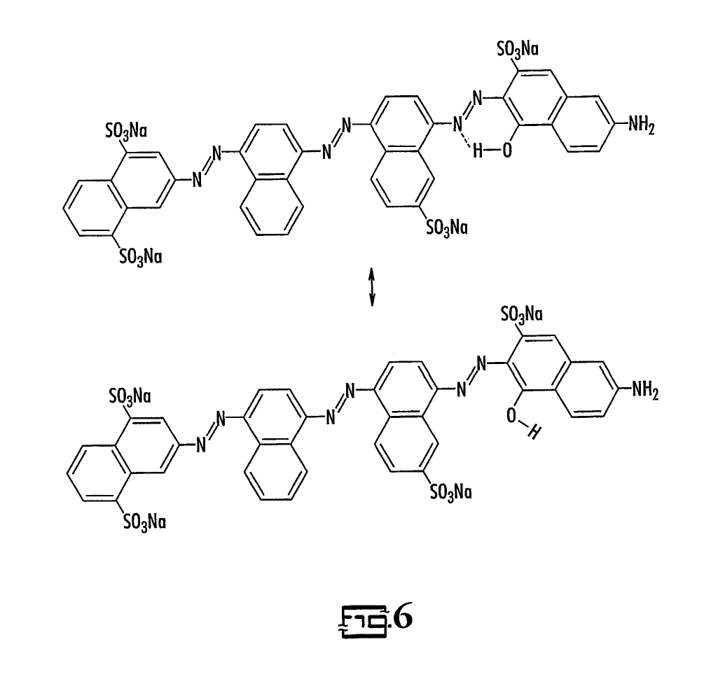

A typical example of dye, which can have two tautomers, is direct blue 71 as shown in FIG. 6. The tautomer which provides blue may be hydrogen bonded (between —O—H and —N═N—) and the hydrogen bonds may be broken in the other tautomer, which would provide red or purple color. The delocalized electrons of the dye molecule can travel over a longer (longer effective conjugation) length in the hydrogen bonded form and hence would appear blue. Once the hydrogen bond is broken, the segments of the molecule can rotate along the single bonds and the molecule may become slightly nonplannar. Such nonplannar molecule would have shorter effective conjugation length and would appear red or purple color.

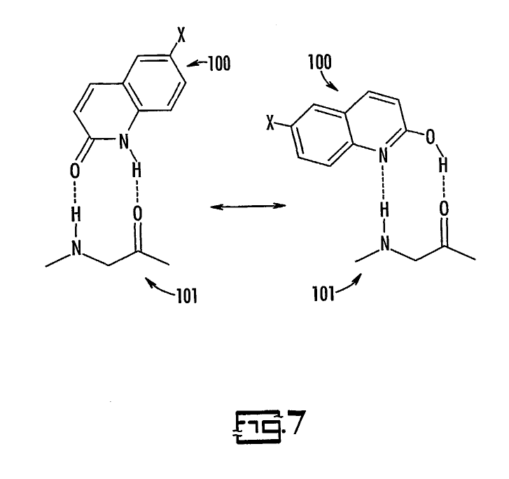

The isomerization of the indicator can also be introduced by interaction with another additive or controller. FIG. 7 shows an isomerization of an indicator molecule, 100, with the amide functionality interacting with a controller molecule, 101, by hydrogen bonding. A color change may be noticeable under UV light.

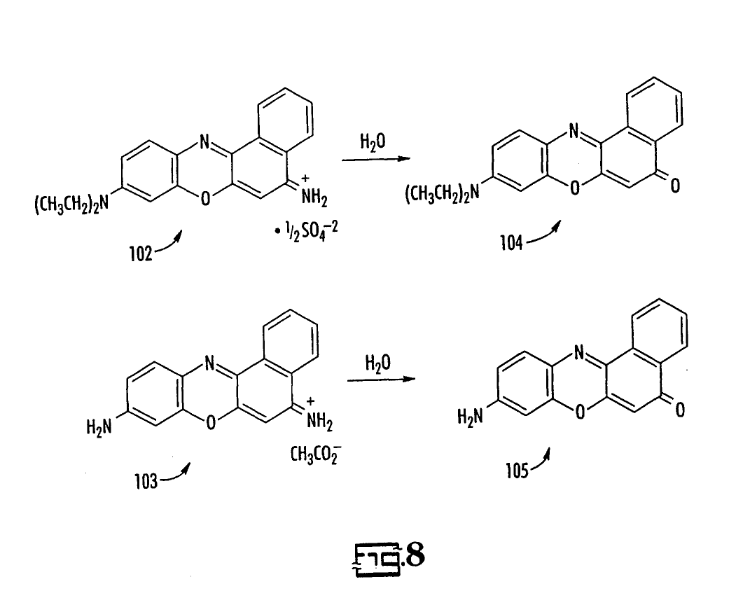

FIG. 8 illustrates isomerization (metachromism) of Nile blue A, 102, to Nile red, 104, and Cresyl violet acetate, 103, to crystal red, 105, which can be introduced by water, water vapor and steam.

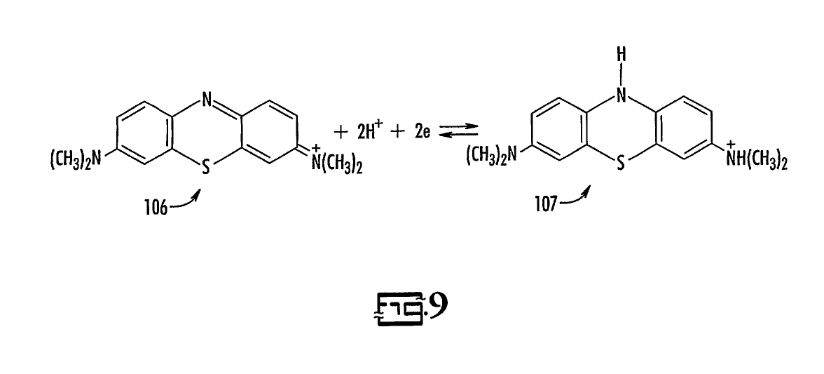

Oxidized (blue colored) and reduced form (colorless) of methylene blue are shown in FIG. 9. A large number of dyes exhibit oxidized and reduced forms. Oxidation can be introduced with an oxidizing agent as a controller and reduction can be introduced with reducing agent as a controller.

The feasibility of the concept was demonstrated by using an acrylate printing ink extender 001270 supplied by Environmental Inks and Coating, Co, Lithicum, Md. as a polymeric binder, direct blue 71 as an indicator and tetramethylhexane diamine as a controller for the indicator. The acrylate ink extender 001270 is referred herein to as EC001270. The mixture of direct blue 71 and tetramethylhexane diamine is purple color in EC001270 and changes to blue when treated with steam. Compounds such as tetramethylhexane diamine, which form or stabilize one of the isomer (e.g., the red/purple color of direct blue 71) are also referred to herein as controllers.

Tautomerism by the way of example of classes also includes acylotropic, alkylotropic, cabonotropic, phosphoryltropic, silylotropic, vinyltropic, and valance tautomerism including π, σ,π-valence tautomerisms. Polar multiple bonds such as C═O, C═N, N═C, N═N, C═C, C═N, and C═C are capable of intramolecular addition of many functional groups such as O—H, N—H, S—H, CO-halogen. Typical examples of such intramolecular reaction include keto-enol, amido-imidol, thiol-thione, and benzoid-quinone. Examples of classes of compounds suitable for indicator and controller include acids, aldehydes, alcohols, amides, amidrazones, amines, azo, dithiocarbamates, esters, hydrazides, hydrazones, hydroxyamines, imidazoles, imadozolines, imides, imines, indolines, ketones, lactams, lactones, mercapto, nitramides, nitriles, nitrones, oximes, pentanediones, phosphates, phthalides, pyrimidines, semicarbazones, thiophenes, thioureas, triazenes, triazoles, and related compounds and derivatives or mixture thereof. Compounds having these functionalities can be used as controllers.

With reduced dyes, oxidizing agents can be used as controllers. Oxidants such as nitrates, nitrites, peroxides, dimethylsulfide, dimethylsulfoxide, hydrogen peroxide-urea complex, carbon tetrachloride, peroxyacids, amine-oxides, alkyl nitrates, alkyl nitrite, complexes of halides such as bromine, per-iodates, per-haloacids and haloates, e.g., perchloric acid and sodium perchlorate, persulfates, e.g., sodium persulfate, metals and metal oxides can be used as oxidants for the device. Oxidants are described in “Oxidation in Organic Chemistry” M. Hudlicky, ACS Washington D.C., Monogram #186, 1990.

With the oxidized form of dyes, reducing agents can be used as controllers. Several classes of reducing agents such as hydrazines, nitrites, thiocyanates, sulfite, sulfides, reduced metal salts, oximes and unsaturated compounds are suitable as reducing agents. Examples of reducing agents are: ammonium sulfite, ammonium thiocyanate, calcium ferrocyanide, Fe(II) salts, sodium bisulfite, sodium cyanate, sodium dithionite, sodium hydrosulfide, sodium sulfite, sodium thiocyanate, sodium thiosulfate, acetone Oxime, benzoquinone dioxime, cupferron, cyclopenatanone oxime, diphenylglyoxime, salicyladoxime, and ascorbic acid.

Solvents for the solvatochromic dyes could be solids or high boiling liquids. Solid solvents are preferred. A powder, e.g, in the form of fine particles, of a solid compound can be mixed with a solvatochromic dye in binder. Upon heating the compound can melt and/or get dissolved and then can dissolve the dye. The dissolution of dye/indicator may be associated with a color change. A large number of compounds, especially organic compounds, which are solid under ambient conditions and get melted or dissolved with water vapor at a higher temperature can be used as controllers for the solvatochromic indicators. The examples of such compounds includes, phenols, polyalcohols, acids, amines, esters, amides, e.g., benzoic acid, diphenyl butyro lactone, glucose pentaacetate, glyconolactone, inositol, chlorinated paraffins, trichlorobenzylacetate, trichloroacetamide, vitamin-c palmitate, tribenzylamine, salicylanamid, hexachloro norborene dicarboxylic acid, and methyldinitrosalicylate.

Any material, which undergoes a color change when treated with water, water vapor including high-pressure steam due to isomerization, with or without indicator controller, can be used as a steam indicator. Steam indicators are also referred herein to as indicators. Most preferred classes of steam indicators are dyes, pigments and their precursors. The dyes having more than one isomers are preferred. Still preferred are the dyes having ability to form and break hydrogen bond or migration of hydrogen atom (process generally preferred as tautomerization). Another class of preferred indicators are dyes which can be oxidized and reduced. Still another class of preferred class of indicators are solvatochromic dyes that can change color when dissolved.

A wide variety of dyes such as nitroso, nitro, azo (mono, di, tri and polyazo), azoic, stilbene, carotenoid, diphenylmethane, triphenylmethane, xanthene, acridine, quinoline, methane and polymethine, thiazole, indamine and indophenol, azine, oxazine, sulfur, lactone, aminoketone, hydroxyketone, anthraquinone, indigoid, phthalocyanine, and natural which have different colored isomeric form or change color in presence of controller when exposed to steam can be used as indicator.

A large number of dyes, as listed in Table 1, were explored with and without a variety of additives as indicator controllers in EC001270 as a polymeric binder. Pieces of the coatings were exposed to steam.

Table 1. List of Dyes and Pigments Tested as an Indicator in EC001270 as a Binder.

Acid alizarin violet N, acid black 24, acid black 48, acid blue 113, acid blue 120, acid blue 129, acid blue 161, acid blue 25, acid blue 29, acid blue 40, acid blue 41, acid blue 45, acid blue 80, acid blue 93, acid fuschin, acid green 25, acid green 27, acid green 41, acid orange 74, acid red 1, acid red 114, acid red 151, acid red 88, acid violet 17, acid violet 7, acid yellow 99, acridine orange, acridine orange base, acridine orange G, acridine yellow G, acriflavine hydrochloride, alcian blue 8GX, alcian yellow, alizarin, alizarin blue black SN, alizarin complexone, alizarin complexone dihydrate, alizarin red, alizarin violet 3R, alizarin yellow GG, alizarin yellow R, alkali blue 6B, alkali fast green 10GA, alphazurine A, aluminon, aminoacridine hydrochloride, aminoanthraquinone, aminophthalhydrazide, aniline blue, astra blue 6GLL, auramine O, azocarmine, azocarmine B, azure A, azure B, azure B thiocyanate, azure C, basic blue 3, basic blue 41, basic blue 66, basic fuchsin, basic red 29, basic yellow 11, benzo purpurin 4B, biebrich scarlet NA salt, bismarck brown B, bismarck brown Y, blue tetrazolium, bordeaux R, brilliant blue B, brilliant blue G, brilliant cresyl blue ALD, brilliant crocein MOO, brilliant green, brilliant sulphaflavine, brilliant yellow, bromochlorophenol blue, bromocresol green, bromocresol purple, bromophenol blue, bromopyrogallol red, bromothymol blue, bromoxylenol blue, calmagite, carbol fuchsin, carminic acid, carotene, celestine blue, Chicago sky blue, chlorophenol red, chrome azurol S, chromotrope 2B, chromotrope 2R, chromoxane cyanine B, chrysoidin, chrysophenine, cibacron brilliant red 3BA, Congo red, copper(II) phthalocyanine, cresol purple, cresol red, cresol, cresolphthalein, cresolphthalein complexone, crystal violet, curcumin, darrow red, diaminoacridine hemisulfate, diazo red RC, dibromofluorescein, dichlorofluorescein, dichloroindophenol, dicinnamalactone, diethylaminomethyl coumarin, diethyloxacarbocyanine iodide, diethylthiatricarbocyanine iodide, dihydroxy benzenesulfonic acid, dilithium phthalocyanine, dimethyl methylene blue, dimethylglyoxime, dimethylindoaniline, dinitro diphenylamine, diphenylthiocarbazone, direct blue 71, direct green 6, direct red 23, direct red 75, direct red 81, direct violet 51, direct yellow 62, disodium phthalocyanine, disperse blue 14, disperse blue 14, disperse blue 3, disperse orange, disperse orange 11, disperse orange 25, disperse yellow 7, emodin, eosin B, cosin Y, eriochrome black T, eriochrome blue black B, erioglaucine, erythrosin B, ethyl eosin, ethyl orange, ethyl red, ethyl violet, Evans blue, fast black, fast blue B salt, fast blue BB, fast blue RR, fast blue RR salt, fast corinth V salt, fast garnet GBC base, fast green FCF, fast red aluminum salt, fast red violet LB salt, fast violet B salt, fat brown RR fat green GDC salt, flavazin I, fluorescein, fluorexon, gallocyarune, guinea green B, hematoxylin, hydroxy naphthol blue, 1,4-hydroxy-naphthoquinone, indigo, indigo carmine, indoline blue, iron(II) phthalocyanine, janus green B, lacmoid, leishman stain, leuco crystal violet, leucomalachite green, leucoquinizarin, light green SF yellowish, lissamine green B, litmus, luxol fast blue, malachite green base, malachite green hydrochloride, malachite green oxalate, metanill yellow, methyl eosin, methyl green, methyl orange, methyl red, methyl violet 2B, methyl violet B base, methyl yellow, methylene blue, methylene green, methylene violet 3RAX, methylesculetin, methylthymol blue, mordant blue 9, mordant brown 24, mordant brown 4, mordant orange, mordant orange 1, mordant orange 6, mordant red 19, mordant yellow 10, morin hydrate, murexide, naphthochrome green, naphthol AS, naphthol blue black, naphthol green B, naphthol yellow, naphtholbenzein, naphtholbenzene, naphtholphthalein, neutral red, new coccine, new fuchsin, new methylene blue N, nigrosin, Nile blue A, Nile blue chloride, nitrazine yellow, nitro red, nitro-phenanthroline, nitrophenol-2, nitrophenol-3, nitrophenol-4, nitrophenylazo-resorcinol, nuclear fast red, oil blue N, oil red EGN, oil red O, orange G, orange II, palatine chrome black 6BN, palatine fast yellow BLN, pararosaniline acetate, pararosaniline base, pararosaniline chloride, patent blue VF, pentamethoxytriphenylmethanol, phenanthroline, phenazine, phenol red, phenolphthalein, phenolphthalein diphosphate, phenothiazine, phenylazoaniline, phenylazodiphenylamine, phenylazoformic acid, phenylazophenol, phloxine B, phthalocynine, pinacyanol chloride, plasmocorinth, ponceau S, primuline, procion red MX-5B, procion yellow H-E3G, prussian blue, purpurin, pyridlazo naphthol, pyridylazoresorcinol sodium salt, pyrocatechol violet, pyrogallol red, pyronin B, quinaldine red, quinizarin, quinoline yellow, reactive black 5, reactive blue 15, reactive blue 2, reactive blue 4, reactive orange 16, resazurin, resorcin crystal violet, rhodamine B, rhodamine B base, rhodamine GG, rhodamine S. rhodanine, rosalic acid, rose bengal, rose bengal iactone, safranine O, solvent blue 35, solvent blue 59, solvent green 3, styryl 7, sudan black B, sudan orange G, sudan red 7B, sulfobromophthalein sodium salt, sulforhodamine B, tartrazine, tetrabromophenol blue, tetrabromo phenolphthalein, tetrabromo phenolphthalein, tetraiodo phenolphthalein, tetraphenyl-butadiene, tetrazolium violet, thiazol yellow G, thioflavin S, thioflavin T, thionin, thymol blue, thymolphthalein, thymolphthalein monophosphate, thymolphthalein monophosphate, toluidine blue O, triphenylmethyl bromide, tropaelin O, trypan blue, tumeric, vanillin azine, variamine blue RT salt, variamine blue RT salt, victoria blue B, victoria blue B, victoria pure blue BO, wright stain, xilidine ponceau 2R, xylenol blue, and xylenol orange.

Some of these dyes are fluorescence dyes and there was a change in fluorescence. The indicators which monitors integral value of time, temperature and humidity are often referred to as steam indicators herein.

A neutral dye or pigment, which does not change color with steam can also be used as an additive to get a series of color changes. For example, addition of a neutral yellow dye or pigment in a dye which changes from colorless to blue with steam (e.g., reduced methylene blue) can provide a series of color change, for example, yellow, yellow-green, green, and blue-green. Similarly, more than one dyes which undergo different color changes, e.g., yellow-to-colorless, red-to-colorless, yellow-red, red-yellow and colorless-to-blue can also be mixed and used to get a series of color change with steam.

Medical supplies are usually sterilized above 100° C., e.g., for about 20 minutes at 125° C. and 5 minutes at 135° C. In order to use an indicator as a steam sterilization indicator for medical supplies, the indicator preferably must not undergo the color change below 100° C. It must also not undergo color change at high ambient temperature and humidity. An indicator made from direct blue 71 and EC001270 does not change color at 80° C. for two weeks and under 100% humidity at 80° C. for a week. Commercially available indicators such as those based on lead, change from red to dark brown within two hours at 80° C. at 100% humidity. The preferred indicators for sterilization of medical supplies are direct blue 71, methylene blue, dispersed blue 14 and iron phenanthroline.

Frozen foods, to be heated either with microwave oven or convention gas or electric ovens, should preferably be heated above at least 80° C, i.e., till some steam is produced. The time required for doneness of the food will depend upon the nature of the food. The indicator to be used for monitoring doneness of food should not change color below about 60° C. An indicator made from methylthymol blue and EC001270 does not change color below 60° C. but change color from red-to-blue in minutes with steam at 80° C. and above. The preferred indicator for doneness of food is methylthymol blue.

Homes, restaurants and catering organizations use kitchenware such as dishes, cutlery and utensils, which need to be sterilized with either dry heat, hot water and steam usually below 100° C. There is also a need for an indicator, for examples, 90° C. for 10 minutes, to make sure the cookware have been subjected to certain integral value of heat and/or humidity. The preferred indicator for kitchenware is also methylthymol blue.

If the device undergoes a color change with humidity only, it can be used as a humidity/moisture indicator.

Any chemical, which can provide a stable isomer of the indicator under ambient conditions and assist or make the indicator to undergo a color change when treated with humidity/steam can be used as an indicator controller. Indicator controllers are also referred to as controllers herein. A controller could also be an isomer or tautomer, oxidizing agent, reducing agent or a solvent. A variety of classes of organic and inorganic compounds can be used as controllers for indicators. They include acetylacetonates, acids, alcohols, aldehydes, amides, amines, azo, bisulfites, bisulfates, carbonates, carbamates, carbazones, chelates, metal complexes, cyanates, esters, halides, halocarbons, imides, imines, ketones, lactams, lactones, mercapto, nitrites, nitrates, nitriles, nitro, nitroso, oximes, pentanediones, phenols, phosphates, sulfates, sulfides, sulfites, thiocyanates, ureas, urethanes, salts, oxidants, reducing agents and solid solvents.

The specific examples of compounds explored as indicator controllers with some selected dyes (e.g., direct blue 71, methylene blue, and methylthymol blue) are listed in Table 2.

Table 2. Exemplary Controllers:

Abietic acid, acetone oxime, aluminum acetylacetonate, aluminum ammonium sulfate, aluminum chloride, aluminum sulfate, amino deoxy d-sorbitol, ammonium acetate, ammonium bisulfite, ammonium bromide, ammonium carbamate, ammonium nitrate, ammonium sulfamate, ammonium sulfite, ammonium thiocyanate, ammonium thiosulfate, ascorbic acid, azodicarbonamide, azodicarbonamide, benzilic acid, benzoic acid, benzophenone, benzophenone tetracarboxylic acid, benzophenonetetracarboxylic diahydride, benzoquinone dioxime, benzoquinone dioxime, benzyloxy)phenol, butyl phenol, caffeine, calcium ferrocyanide, catechol, catechol, chloranilic acid, copper thiocyanate, cupferron, cupferron, cyclopenatanone oxime, dehydroacetic acid, di-butyl-t-4-methylphenol, dihydroxy acetophenone, dihydroxy dimethoxy benzophenone, dihydroxy naphthalein disulfonic acid, dihydroxyacetophenone, dihydroxy-dimethoxybenzophenone, dimethyl fumarate, dimethyl tartrate, diphenyl butyro lactone, diphenylglyoxime, diphenylthiocarbazone, di-t-butyl-4-methylphenol, dithizone or diphenylthiocarbazone, ethylcarbonate, ethylenediamine tetraaceticacid and its salts, ferroin, fumaric acid, gallic acid, gluconic acid fe(ii) salt, glucose penta acetate, glutaaric acid, glycerophosphate, glyconolactone, hexahloro norborene dicarboxylic acid, hydroquinone, hydroxy acetophenone, hydroxy acetophenone, hydroxy cinnamic acid, hydroxy methoxybenzophenone, hydroxy octyloxy benzophenone, hydroxybenzophenone, hydroxymethoxybenzophenone, hydroxyquinoline, hydroxyquinolie, inositol, iron acetylacetonate, iron complexes such as potassium ferrocyanide, iron sulfate, isoascorbic acid, levulinic acid, maleic acid, maleic acid, malic acid, mandelic acid, mercaptobenzothiazole, methyldinitrosalicilate, methyldinitrosalicylate, methylesculetin, methyltrihydroxybenzoate, naphthol, naphthol-disulfonic acid, naphthoquinone tetrasulfate sodium salt, nitron, nitroso-1,2-naphthol, nitrosophenol, oxalic acid, phenanthroline, phthalide, propylgalliate, propylgalliate, pydine aldoxime, pyruvic acid, resorcinol, rutin hydrate, salicyladoxime, salicylanamid, salicylanilide, salicylic acid, sodium acetylacetonate, sodium bisulfite, sodium cyanate, sodium diethyldithiocarbamate, sodium dithionite, sodium hydrosulfide, sodium nitrite, sodium persulfate, sodium sulfite, sodium thiocyanate, sodium thiosulfate, sulfosalicyclic acid 5, tannic acid, tetrabutylphosphonium bromide, tetrahydroxybenzophenone, tetramethylhexane diamine, tetronic acid, tetronic acid, thiodiglycolic acid, thiodipropionic acid, thioglycolic acid, thiourea, tribenzylamine, trichloroacetamide, trichlorobenzylacetate, trihydroxybenzophenone, urea, vitamin-c, and vitamin-c palmitate

Any chemical, which can provide a stable isomer of the indicator under ambient conditions and assist or make the indicator undergo a color change when treated with humidity/steam is a preferred indicator controller. Preferred class of compounds are those which can form hydrogen bonds, e.g., alcohols, amides, amines, acids, bisulfites, bisulfates, carbonates, carbamates, chelates, metal complexes, cyanates, esters, halides, halocarbons, ketones, nitrites, nitrates, nitriles, nitro, nitroso, oximes, phenols, phosphates, sulfates, sulfides, sulfites, thiocyanates, ureas, and urethanes. The most preferred are hydrogen bond forming controllers are aliphatic and aromatic, primary, secondary and tertiary amines. Examples of amines and their salts include adamantanamine, adenine, amino cyclohexanol, amino diethylaminopentane, amino dodecanoic acid, amino ethyl dihydrogen phosphate, amino ethyl hydrogen sulphate, amino pentenoic acid, amino propyl imidazole, amino propyl pipecoline, amino sorbitol, amino undecanoic acid, amino-butanol, aminodeoxy-d-sorbitol, aminoethyl dihydrogen phosphate, aminopropyl imidizole, ammonium acetate, ammonium bromide, ammonium carbaminate, ammonium carbonate, ammonium chloride, ammonium dibydrogen phosphate, ammonium ferrocyanide hydrate, ammonium formate, ammonium hydrogen carbonate, ammonium hydroxide, ammonium iron(ii) sulfate, ammonium iron(iii) citrate, ammonium iron(iii) oxalate trihydrate, ammonium nitrate, ammonium per sulfate, ammonium phosphate dibasic, ammonium sulfamate, ammonium sulfate, benzyl-n-methylethanolamine, benzyltrimethylammonium chloride, bis(dimethylamino) benzophenone, bis(diphenylphosphinopropane), butylimidizole, carbonyldiimidazole, carboxycinnamic acid, chloroethyl-trimethyl, chloroethylamine monohydrochloride, chlorohydroxypropyl trimethyl hydrochloride, chloronitroaniline, choline, choline chloride, choline hydroxide, choline iodide, cyclohexyamine, decylamine, diallyl dimethyl ammoniaum chloride, diaminodiphenylamine, diaminododecane, diaminoheptane, diaminohydroxypropane, diaminononane, diaminooxapentane, diaminopropane, dibutylamino propylamine, dibutyl amino benzaldehyde, diethanolamine, diethyl amine, diethyl aminopropylamine, diisopropyl ethylamine, dimethyl amine, dimethyl amino ethylmethylamino ethanol, dimethyl amino benzaldehyde, dimethyl aminopropoxy benzaldehyde, dimethyl aminopropylamine, dimethyl ammopyridine, dimethyl glycine, dimethyl glyoxine, dimethyl imidizole, dimethyl imidizolidinone, dimethyl propane-diamine, diphenylamine, diphenylamine, diphenylbenzidine, dodecylamine, dodecyltrimethylammoniumbromide, ethanolamine, ethanolamine hydrochloride, ethyl amine, ethyl aminobenzoate hydrochloride, glycidil trimethyl ammonium chloride, histidine, hydroxylamine hydrochloride, hydroxylamine sulphate, imidazole, imidazolidone, iminodiacetic acid, methyl amine, methyl imidizole, nitro anilne, nitro diphenylamine, octa decylamine, phenyl enediamine, polyethylenimine, tetrabutyl ammonium hydroxide, tetrabutyl ammonium iodide, tetraethylammonium bromide, tetraethylammonium hydroxide, tetrafluorophenylimidizole, tetrahexylammonium bromide, tetramethyl ammonium acetate, tetramethyl ammonium chloride, tetramethyl ammonium hydroxide, tetramethyl ethylenediamine, tetramethyl ethylethylenediamine, tetramethyl hexanediamine, tetramethyl propanediamine, tetramethyl quanidine, triallylamine, triethanolamine, triethylamine, triethylenetetramine, triethylenetetramine hydrochloride, triethylethylenediamine, triiodecylamine, trimethyl ammonium chloride, trimethyl-propanediamine, trimethylamine hydrochloride, trioctylamine, trioxa-tridecanediamine, triphenylamine, tris(hydroxymethyl) aminomethane, tris(methoxyethoxy) ethylamine. The preferred controller amines are tetramethylhexane diamine, ethanolamine, ethylene diamine and diethylamine.

The other preferred class of controllers is compounds having ability to isomerize. The preferred isomeric controllers are tautomers. The preferred tautomers are derivatives of CH₃—CO—CH₂—CO—R, e.g., acetoacetic acid and 2,4-pentanedione. The most preferred tautomers are benzylacetoacetate and iron acetylacetonate.

Another class of controllers is reducing agents. The preferred reducing agents are sodium sulfite, sodium hydrosulfite, sodium borohydride, derivatives of ascorbic acid and hydrazines or mixture thereof.

Still another class of controllers is oxidizing agents. The preferred oxidizing agents are perchlorates, nitrates and persulfates, e.g., sodium perchlorate, ammonium nitrate, sodium persulfate.

Concentration of indicator controller required for the noticeable color change depends upon several factors, such as natures of the indicator and controller. Preferred concentration of a controller is 0.1 to 30% of the total solid of the coating. The most preferred range of the controller concentration is 0.5 to 10%.

A matrix or medium in which the controllers, indicators and any other additives can be dissolved or dispersed are referred herein to as binders, polymers or polymeric binders. A wide variety of polymeric materials can be used as binders for the indicator as long as the controllers and indicators can be dissolved or dispersed in them. Both aqueous and non-aqueous binders can be used. Though one can use water-soluble, water-dispersible and polymers soluble in organic solvent as binders for the indicator, it is desirable to use water-soluble and water-dispersible polymers as binders. The binders can be formulated as ink formulations, such as for use as flexo and gravure inks. Other inks such as those for letter press, offset and screen printing, can also be made and used. Selection of a polymer depends upon the printing/coating equipment to be used.

As an alternative to the aforesaid binders, one can use ink and coating formulation curable with UV light. UV curable ink and coating formulations include UV polymerizable/curable compounds such as epoxy-acrylate, polyester acrylates, and resins, typically the acrylates of diphenylol propane di-glycidyl ethers, as their principal component. In order to lower viscosity and to provide a bridge between large polymer molecules, acrylic monomers are used, typically the acrylate esters of polyfunctional alcohols or glycols. The use of monomers as crosslinking agents is vital to the rapid formation of cured films, and has a major influence on the properties of both the ink or coating, and the cured product. Printing inks with epoxy-acrylate resins as their main component are usually fast curing. In order to prepare the device, one can dissolve or disperse, the indicator, controller, and additives in the UV curable extender followed by coating on substrate and curing with UV light UV curable inks which can be used as binders for all kinds of indicators including those for ethylene oxide and plasma can also be used for steam sterilization indicators.

Usually acrylic polymers, emulsion of acrylic polymers, occasionally natural polymers, such as starch, cellulose, lignins and their derivatives are used as binders for inks. Resins are water soluble or emulsifiable through neutralization with basic compounds, such as ammonia and amines. Inks contain a variety of additives to eliminate foaming, dispersion of pigments, Theological modifiers, and slip agents.

Polymeric binders for inks include homopolymers, copolymers and block-copolymers including those of ethylene acrylic acid, ethylene methacrylic acid, ethylene n-butyl acrylate, and ethylene methyl acrylate. Binders for inks could also be a mixture of homo and copolymers, e.g., those of methylmethacrylate, acrylic acid, styrene, methyl acrylate, other esters and crosslinking agents, such as polyaziridines and divalent metal salts such as zinc hydroxide.

Commercial sources for suitable polymers for ink formulations include Air products (Allentown, Pa.), Rohm and Haas (Philadelphia, Pa.), S.C. Johnsons and Sons (Racine, Wis.), Witco (Houston, Pa.) and ESI (Valley Stream, N.Y.). Though a large number of polymers are suitable as ink extenders, EC001270 made by Environmental Inks and Coating Co., Lithicum, Md. which is composed about 40% styrene-acrylic polymers, a few percent ammonium hydroxide, additives, such as a polymeric wax and an antifoaming agent, alcohol and the balance water, has been found very suitable.

Though aqueous ink or coating formulations are preferred, one can use solvent based coating formulations polymers used in such formulations are cellulose nitrate, carboxymethyl cellulose, polyolefins, polyvinyl chloride, polyurethane, polysilicones and polyepoxy and UV curable ink formulations.

When all components of the inks are readily soluble in water, one can make an ink for jet ink printer and indicator device can be made using an inkjet printer.

The sterilization of an article will also depend on diffusion of steam through the binder. Hence, the time required for the color change of the device can be increased by applying a barrier coat or laminating a film on the device. A barrier coat, or topcoat, can preferably be a polymeric material. The preferred barrier coat is a lacquer or an ink without pigment. The barrier coat can be a polymer listed herein. The general classes of polymers suitable for a barrier coat include resins, such as epoxy, phenol-formaldehyde, amino-formaldehyde, polyamides, vinyls, acrylics, polyurethanes, polyesters, water-soluble resins, alkyds, elastomers, waxes and rosins. Preferred material for topcoat is a paraffin wax through which steam can diffuse slowly.

The device could have more than one indicator layers each containing indicator, controller and binders. In order to get more than one color change at least the indicator should be different in different indicator layers and should undergo different color changes. Both layers do not have to undergo color changes with steam. Even if one layer undergoes a change in color or opacity, the color change of the other can be noticed, especially if the top layer becomes colorless or transparent.

Indicator can have an optional topcoat or can be laminated with a transparent film The indicator can also be sandwiched between two layers, one preferably clear for viewing color change.

Desired colors and color changes can be obtained by mixing proper dyes in appropriate amounts. Similarly, the time required for the color change can be varied by using a proper mixture of the indicators, controllers and additives in appropriate amounts. The desired colors and the time required for the color changes can be obtained by selecting a proper mixture of compatible binders, additives and controllers.

Though the device could be a self-supporting polymer film containing the controller and indicator, it is desirable to prepare the device on a substrate. The device can be made by coating the indicating formulation on a substrate. The substrate could be any solid surface, for example, that made from paper, plastic, ceramic and metal.

The substrate could be a container, e.g., bag, pouch, can or container lid, for items to be sterilized or food to be cooked. The sterilization indicator can also be prepared in form of stickers, strips and tapes.

Although any solid substrate having a smooth surface can be used, a preferred substrate is a flexible and transparent plastic film, and natural (cellulose) and synthetic (e.g., spun bonded polyolefins, e.g., Tyvak®) papers. Plastic films, such as polyethylene, polypropylene, polyvinyl chloride, polymethylmethacrylate, polyurethanes, nylons, polyesters, polycarbonates, polyvinyl acetate, cellophane and esters of cellulose can be used as the transparent substrate. Metal foils, such as aluminum can be used. The most preferred substrates are the 5-300 microns thick films of polyethylene terephthalate, cellulose paper and Tyvak®.

The indicator could be in the form of any shape, e.g., dot, square, rectangle, picture, image and message.

The indicator can undergo a color change from a very low temperature (e.g., room temperature) to a very high temperature (e.g., 150° C.) of pressurized steam. The preferred temperature for the color change depends upon the application of the indicator. For monitoring doneness of a food and sterilization of kitchenware, the temperature could be between 60° C. and 100° C. For monitoring steam sterilization of canned foods the temperature could vary from 80° C. to 120° C. and that of medical supplies it could vary from 100° C. to 150° C. The preferred temperature range is 80-140° C.

The time required for the color change can be varied by varying one or more of the following parameters: thickness of the binder and the indicator layer; thickness of the barrier coat; concentration of the controller; concentration of the indicator; concentration of other additives; nature of the binder, nature of the barrier; nature of the controller; nature of the indicator; nature of the additives; and concentration of water vapor.

The thickness of the indicator and barrier layers may vary from a micron to five hundred microns. The preferred thickness is approximately 1-50 microns and the most preferred thickness is approximately 2-20 microns.

The concentration of controller may vary from 0.1 to 50 w/w %. The preferred concentration is 1 to 20 w/w % and the most preferred concentration is 2-10 w/w %.

The concentration of the indicator may vary from 0.1 to 30 w/w %. The preferred concentration is 1 to 10 w/w % and the most preferred concentration is 2-5 w/w %.

The concentration of additives such as crosslinking agents, plasticizers, stabilizers and UV absorber may vary from 0.1 to 20 w/w %. The preferred concentration is 0.5 to 10 w/w % and the most preferred concentration is 1-5 w/w/%.

The time required for the color change will depend upon concentration of steam or humidity and the application of the device. For kitchenware water vapor concentration could be as low as 5% and that for steam sterilization of medical supply, one can use completely saturated steam. The time required for the color change will be shorter with higher concentration of steam/humidity and vice versa. Higher humidity increased the time required for the color change. The preferred concentration is saturated steam.

The classes and specific polymer listed herein can be used and preferred as binder and barrier polymers. Preferred binders are polyacrylates.

The classes and specific controllers, indicators, and additives listed herein can be used and preferred as controllers, indicators, and additives.

The preferred time range for the indicator will depend upon the application and the temperature of sterilization. The preferred time for sterilization is from 1 to 100 minutes. The most preferred time is 2 to 30 minutes. The preferred time range for doneness of food and sterilization of kitchenware also depend upon the temperature of the warm up. The preferred time for doneness of the food is from 1 to 100 minutes. The most preferred time is 2 to 15 minutes.

We have found that most of the formulations reported herein were not effected by ethylene oxide, plasma and normal ambient conditions such as humidity and light.

The devices described here are integrators, i.e., they monitor integral value of time, temperature and water vapor.

The device offers many advantages including: the formulations are inexpensive; the ingredients are considered nontoxic; it is easy to make the ink formulations, just by mixing proper ingredients in an ink extender, the device is selective to water vapor and steam; the device is unaffected by ethylene oxide, dry heat and radiation; it is unaffected by sealing hot bar, the ink has required pot life; there is no bleeding/diffusion of dyes; the ingredients (indicators/dyes and controllers/additives) are water soluble; no grinding of ingredients is required; ink is printable with gravure and flexo presses on polyester, paper and type; the print rolls are easy to clean; the time required for the color change can be varied by simple means; and it provides desired color changes (from a starting light color, such as orange, pink, or red to a final dark color, such as blue, green, black, purple or violet).

### EXAMPLES

### Example 1

General Procedure for Preparation of the Sample Devices.

In a 10 ml test tube were added about 25 mg of a controller (e.g., tetramethylhexane diamine) and about 0.5 ml of an indicator solution (e.g., 4 w/w % solutions of direct blue 71 in water). The content is mixed and heated if required. In the mixture was added about 1 g of EC001270. In order to control the diffusion of steam, some times solution of a polyaziridine or ammonical zinc oxide was added. The contents were mixed and coated with #5 or #10 wire wound rod on a 100 micron polyester film and paper. The coatings were dried in an oven at about 50° C. for about a few minutes.

### Example 2

Exposure to Steam and Humidity

Samples of example 1 were placed in a (1) humidity chamber e.g., 100% humidity at 60 or 70° C. and (2) in a pressure cooker at ˜123° C., i.e. at 25 lbs, for different periods. The color changes of the samples were noted. Some samples were exposed to steam at 134° C. for 1 to 6 minutes. In order to determine selectivity, some samples were also exposed to ethylene oxide (e.g., 100% gas for about 3 hours) and dry heat (usually for 16 hours at 70° C.).

### Example 3

Different Dyes and Controllers.

Using the general procedure described in example 1, coatings were prepared from EC001270 as a binder, tetramethylhexane diamine, aluminum acetylacetonate, sodium acetylacetonate, benzylacetylacetonate, sodium sulfite, ascorbic acid, sodium thiocyanate and tetraethylammonium bromide as controllers, and most of the dyes listed in Table 1 as indicators. The coatings were exposed to steam for 20 minute at 123° C. Some representative color changes are listed Table 3.

TABLE 3
Representative color changes of some dyes with EC001270

| Dye | Controller | Original | Steam treated |
|---|---|---|---|
| Direct blue 71 | None | Light-blue | Blue |
| Direct blue 71 | TMHDA | Red-purple | Blue |
| Direct blue 71 | SS | Faint blue | Blue |
| Methylthymol blue | None | Orange | Red |
| Methyl thymol blue | AAA | Red | Blue |
| Auramine O | None | Yellow | Colorless |
| Methylene blue | SS | Light red | Blue |

TMHDA: Tetramethylhexane diamine, AAA: aluminum acetylacetonate, and SS: sodium sulfite

### Example 4

Pilot Coating of Methylthymol Blue as an Indicator and Aluminum Acetylacetonate as a Controller.

Using the general procedure of example 1, an ink formulation was prepared by mixing 1250 g of EC001270 as binder, 50 g of methylthymol blue [3,3′-bis{N,N-di(carboxymethyl)-aminomethyl}thymolsulfonephthalein] as an indicator and 20 g of aluminum acetylacetonate dissolved in 200 g of methanol as a controller. The mixture was coated on paper and polyester film using a pilot coater of Rexam Medical Packaging, Mt Holly, N.J. The coatings were burgundy red color. When treated with water vapor (steam) above about 60° C., it changed to blue color. The time required for the color change depend upon the temperature of the vapor. The higher the temperature shorter was the time. For example, it changed to blue within a minute at 100° C. while it took about 10 minutes to change at 90° C.

This indicator can be used for monitoring doneness of microwave food and sterilization of kitchenware.

Addition of controllers such as aminocaproic acid, dimethylethanolamine, gluconic acid-iron salt, histidine, thiourea, and calcium acetylacetonate varied the time required for the color change.

### Example 5

Direct Blue 71 as Indicator

Using the general procedure of example 1, an ink formulation was prepared by mixing 1000 g of EC001270 as binder, 20 g of direct blue 71 as an indicator and 20 g of tetramethylhexane diamine as a controller and 25 g of 20% zinc oxide solution. The mixture was coated on paper and polyester film. The coatings were purple color and changed to blue color when exposed to steam.

A large number of additives, e.g., those listed in Table 2 were added as controllers instead of tetramethylhexane diamine. Many salts and amines were effective controllers. They include benzylmethylethanolamine, cyclohexylamine, 1,12-diaminododecane, 1,5-diaminopropane, dibutylamino propylamine, dibutyl amino-benzaldehyde, diethanolamine, diethyl amine, dimethyl amine, dimethylethanolamine, diphenylamine, ethanolamine, ethylene diamine guanidine carbonate, hexanediamine, hexylamine, histidine, lysine, morpholine, potassium nitrate, sacrosine, sodium chloride, sodium thiocyanate, 1,1,3,3-tetramethyl guanidine, tetraethylammonium hydroxide, tetramethylethylene diamine, triethanolamine, triethylenetetramine, and trihydroxymethylaminomethane and zinc oxide. Certain reducing agents such as ascorbic acid and sodium sulfite as controller provided almost colorless (faint blue coating) coating which turned blue when treated with steam.

### Example 6

Different Colors with Other Dyes.

In about 1 g indicator ink of formulation of direct blue 71 of example 5 were added about 0.25 ml of 4% solution of the dyes listed in Table 1. The mixtures were coated on paper and polyester. Many dyes provided different starting, intermediate and final colors. Some representative examples are shown in Table 4.

TABLE 4
Some representative examples of color change
direct blue 71 and some dyes upon steam treatment.

| Added dye | Original color | After steam treatment |
|---|---|---|
| Auramine-O | Khaki yellow → | Green-blue |
| Quinoline yellow | Purple | Green-blue |
| Rhodamine | Purple | Blue |
| Bromocresol purple | Purple | Green-blue |
| pararosaniline acetate | Red | Violet-blue |
| Brilliant crocein MOO | Red | Blue |

### Example 7

Oxidizing Agents as Controllers.

Using the general procedure described in example 1, coatings were prepared from EC001270 as a binder containing 10% ammonium nitrate as controller and most of the dyes listed in Table 1 as indicators. Perchloric acid and potassium persulfate were also very effective controllers. The coatings were exposed to steam for 20 minute at 123° C. Some representative color changes are listed Table 5.

TABLE 5
Representative examples of color change of some dyes
with sodium nitrate upon steam treatment.

| Dye | Original color | After steam treatment |
|---|---|---|
| Acid red 88 | Light red | Red |
| Acid alizarin violet N | Light violet | Violet |
| Benzo purpurin 4B | Red | Light red |
| Chrysophenine | Light yellow | Yellow |
| Direct red 75 | Light red | Red |
| Acid blue 113 | Blue | Purple |
| Leuco crystal violet | Colorless | Violet |
| Bromophenol blue | Light blue | Blue |
| m-Cresol purple | Orange | Yellow |
| Dimethylmethylene blue | Light blue | Blue |
| Pyrogallol red | Purple | Blue |
| Nile blue chloride | Light blue | Blue |
| Methylene blue | Light blue | Blue |

### Example 8

Solid Solvents as Controllers.

Coatings were prepared from 1 ml of EC001270 as a binder containing 10% finely milled glucose pentaacetate as a controller and 0.5 ml of 4% solution of most of the dyes listed in Table 1 as indicators. The coatings were exposed to steam for 20 minute at 123° C. Some representative color changes are listed Table 6.

TABLE 6
Representative examples of color change of some dyes with glucose
pentaacetate as a controller upon steam treatment.

| Dye | Original color | After steam treatment |
|---|---|---|
| Chrysoidin | Orange | Yellow |
| Bismarck brown Y | Orange | Colorless |
| Congo red | Red | Colorless |
| Bromopyrogallol red | Purple | Black blue |
| Nile blue chloride | Light Blue | Blue |
| Darrow red | Light pink | Yellow |
| Disperse blue 14 | Colorless | Blue |
| Solvent blue 59 | Colorless | Blue |
| Oil blue N | Colorless | Blue |
| Solvent green 3 | Colorless | Green |
| Eriochrome blue black B | Red | Purple |
| Hematoxylin | Light purple | Purple/blue |

### Example 9

Reducing Agents as Controllers.

Using the general procedure described in example 1, coatings were prepared from EC001270 as a binder, sodium sulfite as controller and most of the dyes listed in Table 1 as indicators. The coatings were exposed to steam for 20 minute at 123° C. Some representative color changes are listed in Table 7.

TABLE 7
Representative examples of color change of some dyes
with sodium sulfite upon steam treatment.

| Dye | Original color | After steam treatment |
|---|---|---|
| Janus green B | Purple | Blue |
| Indoline blue | Red | Blue |
| Acid blue 93 | Light blue | Blue |
| Brilliant crocein MOO | Yellow | Red |
| Guinea green B | Colorless | Green |
| Naphthochrome green | Colorless | Blue |
| Methylene blue | Colorless | Blue |
| Thionin | Red | Blue |
| Leishman stain | Red | Blue |

With the above representative examples, we have demonstrated that many dyes and pigments can be made to undergo a color change with controllers such as amines, salts, oxidizing agents, reducing agents and solid solvents. The color change could be due to isomerization of the dye/pigment molecules, oxidation, reduction, dissolution or combination of them.

Even though we have given some representative examples of dyes, a large number of other dyes, pigments and their mixtures can be used. Similarly, one can use a mixture of controllers and stabilizers to stabilize the isomorphic forms.

Clearly, it should now be quite evident to those skilled in the art, that while my invention was shown and described in detail in the context of a preferred embodiment, a wide variety of other modifications and variations can be made without departing from scope of my inventive teachings.

I claim:

1. A device for monitoring integral value of time, temperature and water vapor comprising at least one layer of polymer comprising an isomeric indicator capable of undergoing at least one color change, a controller for said indicator capable of influencing the time and temperature required for said color change when contacted with water vapor, wherein said indicator undergoes an isomerization reaction which causes said indicator to undergo said color change.

2. The device of claim 1 where isomerization is due to phase change, polymorphism, tautomerism, dissolution, oxidation or reduction.

3. The device of claim 2 wherein said indicator has at least two isomeric forms each having different colors.

4. The device of claim 2 where said color change is due to dissolution of said indicator.

5. The device of claim 2 where said color change is due to oxidation of said indicator.

6. The device of claim 2 where said color change is due to reduction of said indicator.

7. The device of claim 1 wherein said indicator comprises at least one member of the group consisting of pigments, dyes, and precursors of dyes and pigments.

8. The device of claim 7 wherein said indicator comprises at least one member chosen from the group consisting of acid alizarin violet N, acid blue 113, acid blue 93, acid red 88, auramine-O, azures, benzo purpurin 4B, bismarck brown Y, brilliant crocein MOO, bromocresol purple, bromophenol blue, bromopyrogallol red, chrysoidin, chrysophenine, Congo red, darrow red, dimethylmethylene blue, direct blue 71, direct red 75, disperse blue 14, eriochrome blue black B, Guinea green B, indoline blue, Janus green B, leuco crystal violet, meta-cresol purple, methylene blue, methythymol blue, naphthochrome green, Nile blue chloride, oil blue N, pararosaniline acetate, pyrogallol red, quinoline yellow, rhodamine, solvent blue 59, solvent green 3, and thionin.

9. The device of claim 1 where said layer comprises said indicator and at least one neutral coloring material which does not change color with humidity.

10. The device of claim 1 wherein said color change is selected from a group consisting of red-to-blue, purple-to-blue, yellow-to-blue, colorless-to-green, colorless-to-blue, colorless-to-red, blue-to-red, red-to-yellow, and green-to-colorless.

11. The device of claim 1 wherein said polymer is soluble in an organic solvent.

12. The device of claim 1 wherein said polymer is soluble in water or is water dispersible.

13. The device of claim 12 wherein said polymer is a water soluble or water dispersable homopolymer, copolymer or a mixture thereof.

14. The device of claim 1 wherein said polymer comprises polymerized monomers of styrene, acrylate, acrylic acid, acrylamide, vinyl acetate, vinyl alcohol, vinyl chloride, polyurethanes, cellulose nitrate and carboxymethyl cellulose.

15. The device of claim 1 wherein said polymer is a homopolymer, copolymer or a mixture thereof.

16. The device of claim 1 wherein said polymer is an acrylate polymer.

17. The device of claim 1 wherein said polymer is cellulose nitrate or carboxymethylcellulose.

18. The device of claim 1 wherein said polymer is formed by high energy radiation.

19. The device of claim 1 said polymer is formed by UV light and electron beam.

20. The device of claim 1 wherein said controller is present in an amount of 0.1 to 50%, by weight.

21. The device of claim 20 where said controller is capable of introducing isomerization.

22. The device of claim 1 where said controller comprises a salt, amine, metal chelate, chelating agent, oxidizing agent, reducing agent or solid solvent.

23. The device of claim 22 where said salt is chosen from a group consisting of sodium chloride, sodium thiocyanate and zinc oxide.

24. The device of claim 22 where said amine is chosen from a group consisting of tetramethylhexane diamine, diethylamine, ethylene diamine, diethanolamine, and cyclohexylamine.

25. The device of claim 22 where said oxidizing agent comprises a compound chosen from a group consisting of nitrates, peroxides, persulfates, perchlorates, per-iodates, peroxyacids, amine-oxides, alkyl nitrates, complexes of halides such as bromine, and oxidized metal salts.

26. The device of claim 22 where said oxidizing agent comprises a compound chosen from a group consisting of ammonium nitrate, hydrogen peroxide and sodium persulfate.

27. The device of claim 22 where said reducing agent is chosen from a group consisting of borohydride, sulfite, sulfide, nitrite, salt of a reduced metal, hydride, hydrosulfite, hydazine, oxime, and unsaturated organic compound.

28. The device of claim 22 wherein said reducing agent is chosen from a group consisting of ascorbic acid, sodium sulfite, sodium hydrosulfite, sodium borohydride, sodium nitrite, hydrazine or its derivatives, ammonium sulfite, ammonium thiocyanate, calcium ferrocyanide, Fe(II) salts, isoascorbic acid, sodium bisulfite, sodium cyanate, sodium dithionite, sodium hydrosulfide, sodium sulfite, sodium thiocyanate, sodium thiosulfate, benzoquinone dioxime, cupferron, cyclopenatanone oxime, diphenylglyoxime, salicyladoxime, ascorbic acid and a derivative of ascorbid acid.

29. The device of claim 22 where said chelating agent comprises a compound chosen from a group consisting of benzylacetylacetonate, iron acetylacetonate, and aluminum acetylacetonate.

30. The device of claim 22 where said solid solvent melts below 150° C. or is dissolved with water vapor.

31. The device of claim 22 where said solid solvent comprises a compound chosen from a group consisting of phenol, polyalcohols, acids, amines, esters, amides, lactones, parafins and halogenated parafins.

32. The device of claim 22 where said solid solvent comprises a compound chosen from a group consisting of benzoic acid, diphenyl butyro lactone, glucose pentaacetate, glyconolactone, inositol, chlorinated paraffins, trichlorobenzylacetate, trichloroacetamide, vitamin-c palmitate, tribenzylamine, salicylanamide, and hexachloro norborene dicarboxylic acid.

33. The device of claim 1 wherein the said controller is capable of influencing said time and said temperature required for said color change.

34. The device of claim 1 further comprising a second indicator layer.

35. The device of claim 1 further comprising a polymeric top layer.

36. The device of claim 1 further comprising a wedge shaped polymeric top layer.

37. The device of claim 1 further comprising plurality of devices wherein said plural devices comprise plural indicators and undergo color changes independently.

38. A process of making the device of any of claims 1-37 comprising:
a) dissolving or dispersing said indicator in a solvent to form a solution;
b) applying said solution to a substrate;
c) permitting said solvent to evaporate.

39. The process of claim 38 wherein said substrate is a container for an item to be sterilized.

40. The process of claim 38 wherein said substrate is chosen from plastic film, paper and metal.

41. The process of claim 38 wherein said substrate comprises polyester film, paper or spun bonded polyolefins.

42. The process of claim 38 wherein said solution is an ink formulation.

43. The process of claim 42 wherein said solution is an aqueous ink formulation.

44. The process of claim 42 wherein said ink formulation comprises an acrylate polymer.

45. The process of claim 38 wherein said solution is applied to said substrate by a spraying.

46. The process of claim 45 wherein said spraying is a jet spray.

47. A process of using a device of any of claims 1-37 for monitoring sterilization of materials comprising the steps of:
a) affixing said device to said materials or containers containing said materials;
b) carrying out a process of sterilization;
c) introducing steam during said process of sterilization; and
d) observing a color change indicating said sterilization has proceeded.

48. The process of claim 47 wherein said material is a medical supply, a food, a pharmaceutical, or a biological waste.

49. A process of using the device of claim 1 for monitoring steam comprising the steps of:
a) exposing said device to steam,
b) observing a color change in said device.

50. A formulation for making the device of claim 1 comprising a polymeric binder, indicator, controller and solvent.

51. The formulation of claim 50 further comprising a polymer of any of claims 11-19.

52. The device of claim 1 comprising 50-100%, by weight, of said isomeric indicator.
